(19) United States
(12) Patent Application Publication
(10) Pub. No.: US 2012/0266505 A1
(43) Pub. Date: Oct. 25, 2012

(54) MULTIFUNCTIONAL POSTCARD STRUCTURE AND MANUFACTURING METHOD THEREOF

(76) Inventor: KAI-JSE HUNG, TAOYUAN COUNTY (TW)

(21) Appl. No.: 13/091,299

(22) Filed: Apr. 21, 2011

(51) Int. Cl. G09F 1/04; B31B 17/00; B42D 15/04

(52) U.S. Cl. 40/124.09; 493/84

(57) ABSTRACT

In a multifunctional postcard structure and its manufacturing method, the structure comprises: a transparent board, being a rectangular flat board structure with four edges, and any three successive edges of the transparent board having a folding board; a first board, attached onto the same side of the folding boards, and a containing space being formed between the transparent board and the first board; a second board, attached onto the other side of the folding boards, and the folding boards being covered between the first board and the second board; and a content, placed in the containing space, and having a pattern area defined on a surface of the content and viewable through the transparent board directly. With the design capable of changing the content quickly, the viewing effect can be changed during use. In addition, the content comes with a bookmark design to improve the practicability of the postcard structure.

### BACKGROUND OF THE INVENTION

1. Field of the Invention

The present invention relates to the field of postcard covers, in particular to a multifunctional postcard structure with a design capable of changing its pattern, providing a bookmark and using the structure as a photo frame and a manufacturing method of the multifunctional postcard structure.

2. Description of the Related Art

Postcard is designed with an enjoyable planar drawing and intended for writing a letter and mailing it out from a post office without the need of an envelop, and the postcard has the advantages of saving postage and the cost of the envelope.

However, the postcard has a drawback of providing a small space for writing and failing to keep confidential information, and thus it is generally used for writing contents without confidentiality, and communicating with one's family and friends through brief words.

With reference to FIG. 1 for a schematic view of a general postcard structure, the postcard 1 is a card made of paper and having both top and bottom sides, wherein a writing area 11 is provided at the top side and printed according to the format of a letter, and a blank area 12 is provided at the bottom side for writing. The blank area 12 of the postcard 1 provided for writing is combined with a pattern 13 such as a picture of a landscape, an animal, a plant, a cartoon, or a special designed pattern, and the pattern 13 is printed at the blank area 12 directly to enhance the visual appreciation and the storage value of the postcard 1. Therefore, users generally write brief words or simple messages in the blank area 12 or a side of the pattern 13 of the postcard 1 before mailing it to their family or friends.

Upon the receipt of the postcard, a receiver can view and enjoy the pattern 13 printed on the postcard 1 and then store the postcard 1 in a postcard collection. If the receiver has not stored the postcard in a good place and want to view the postcard again, it will take much time for the user to look for the postcard, thus causing tremendous inconvenience to the user. Regardless of functions or applications, a general postcard 1 is dull, and obviously requires improvements.

In view of the foregoing problem, the inventor of the present invention developed a multifunctional postcard structure and its manufacturing method, wherein the postcard structure comes with a containing space for placing at least one content such as a card, a photo, or a magnet and provides different visual views (such as 3D views). In addition, the postcard further includes a foldable shelf provided for using the postcard structure as a photo frame. The content can further include a bookmark to enhance the functionality and practicability of the present invention.

### SUMMARY OF THE INVENTION

Therefore, it is a primary objective of the present invention to provide a postcard structure with a photo changing function, and the postcard has a containing space formed therein for placing at least one content, and allows users to save a content with different patterns, replace the content quickly and achieve different viewing effects.

Another objective of the present invention is to provide a postcard structure with a photo frame function, wherein a foldable shelf is formed on a side of the postcard and used as a photo frame to improve the practicality of the present invention significantly.

Another objective of the present invention is to provide a multifunctional postcard structure, wherein the content has a detachable bookmark to improve the practicality of the present invention significantly.

To achieve the foregoing objectives, the present invention provides a multifunctional postcard structure and a manufacturing method thereof, and the multifunctional postcard structure comprises:

a transparent board, being a rectangular flat board structure with four edges, and having any three successive edges coupled to a folding board separately;

a first board, attached onto the same side of the folding boards, and a containing space being formed between the transparent board and the first board;

a second board, attached onto the other side of the folding boards, and the folding boards being covered between the first board and the second board; and

a content, placed in the containing space, and having a pattern area defined on a surface of the content and viewable through the transparent board directly.

Wherein, the transparent board further has a sealing board coupled to an edge without the folding board, and the sealing board is substantially in a triangular shape, and a corner of the sealing board not connected to the transparent board is folded into the containing space; a writing area is defined on a surface of the second board; the content further includes a bookmark attached onto the pattern area; and the transparent board and the bookmark are made of a non-toxic green plastic material, and the first board, the second board and the content are made of a cardboard material.

In a preferred embodiment, the second board further includes a foldable shelf. The foldable shelf includes a longitudinal board and a transverse board, and both longitudinal board and transverse board are coupled to the second board. If the longitudinal board and the transverse board are perpendicular to the second board, the longitudinal board and the transverse board are latched with each other. The second board further includes a shelter portion disposed on a surface where the second board and the folding boards are attached.

In addition, the present invention further provides a manufacturing method of the multifunctional postcard structure, and the manufacturing method comprises the steps of: setting the first board on a surface of the transparent board, and folding the folding boards towards the first board, and attaching the folding boards onto a surface of the first board to form a containing space between the transparent board and the first board; attaching the shelter portion of the second board onto a side of the first board, such that the folding boards are included between the second board and the first board; attaching a portion of the second board to a side of the shelter portion, such that the foldable shelf of the second board which is not adhered is movable; and inserting the content into the containing space, and folding the sealing board into the containing space, such that the content is covered in the containing space completely without falling out.

### BRIEF DESCRIPTION OF THE DRAWINGS

FIG. 1 is a schematic view of a conventional postcard;

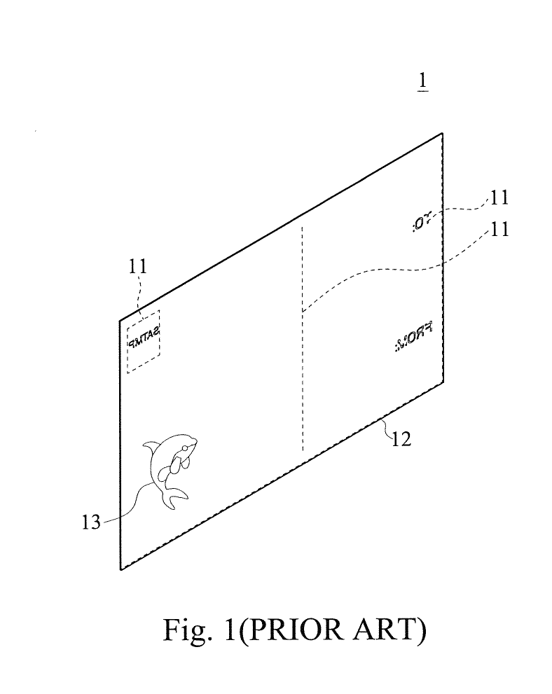

FIG. 2 is an exploded view of a preferred embodiment of the present invention;

FIG. 3 is a first schematic view of an assembling procedure of a preferred embodiment of the present invention;

FIG. 4 is a second schematic view of an assembling procedure of a preferred embodiment of the present invention;

FIG. 5 is a third schematic view of an assembling procedure of a preferred embodiment of the present invention;

FIG. 6 is a fourth schematic view of an assembling procedure of a preferred embodiment of the present invention;

FIG. 7 is a first schematic view of an operating procedure for an application as a photo frame in accordance with a preferred embodiment of the present invention;

FIG. 8 is a second schematic view of an operating procedure for an application as a photo frame in accordance with a preferred embodiment of the present invention; and

FIG. 9 is a manufacturing flow chart of a preferred embodiment of the present invention.

### DETAILED DESCRIPTION OF THE PREFERRED EMBODIMENTS

The technical contents and characteristics of the present invention will be apparent with the detailed description of preferred embodiments together with accompanying drawings as follows:

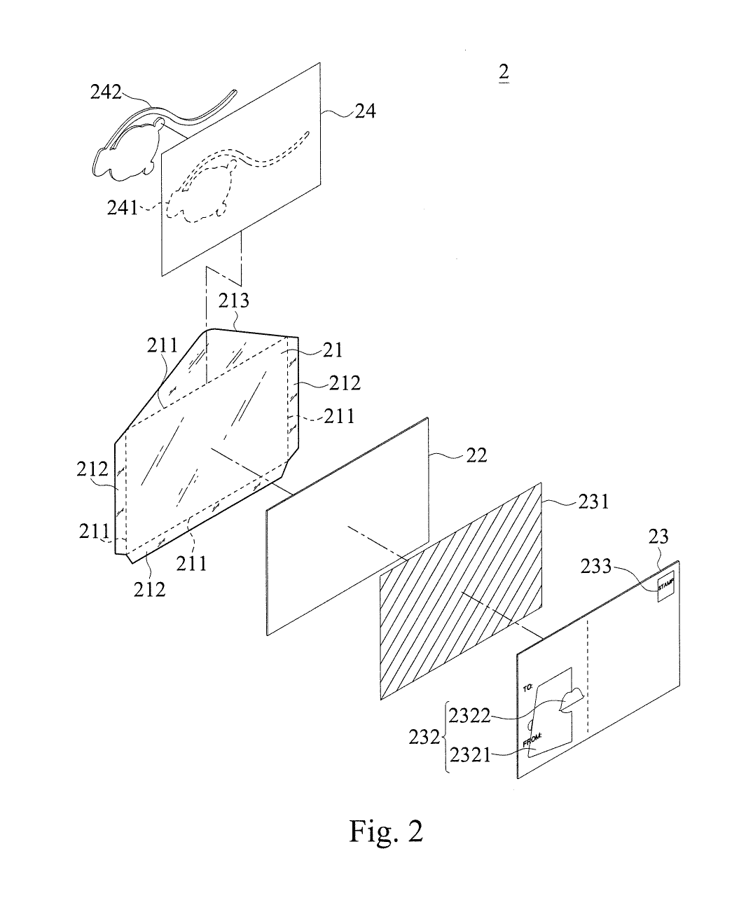

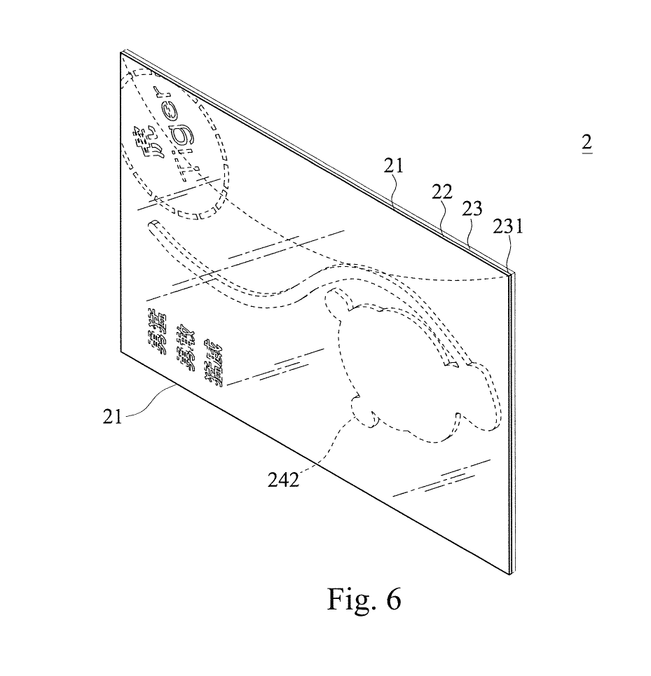

With reference to FIGS. 2 and 3 to 6 for an exploded view and schematic views of assembling a multifunctional postcard structure in accordance with a preferred embodiment of the present invention respectively, the multifunctional postcard structure 2 comprises a transparent board 21, a first board 22, a second board 23 and a content 24.

The transparent board 21 is a rectangular flat board structure made of a non-toxic green plastic material, and the transparent board 21 has four edges 211, and a folding board 212 is coupled to any three successive edges 211 of the transparent board 21 separately, and the folding board 212 is substantially in a trapezium shape, and the folding boards 212 are folded along the edges 211 respectively towards the transparent board 21. It is noteworthy to point out that the non-toxic green plastic material is one selected from the collection of polypropylene (PP), ethylene vinyl acetate (EVA) and high density polyethylene (HDPE). Further, the transparent board 21 further includes a sealing board 213 coupled to an edge 211 without the folding board 212, and the sealing board 213 is substantially in a triangular shape.

The first board 22 is made a cardboard cut into a card structure with a shape and a size corresponding to those of the transparent board 21, and the first board 22 is attached onto the same side of the folding boards 212 (such as the internal side of the folding boards 212 as shown in the figure), such that a containing space 221 is formed between the transparent board 21 and the first board 22, and a corner of the sealing board 213 not coupled to the transparent board 21 is folded into the containing space 221.

The second board 23 is also made of a cardboard cut into a card structure with a shape and a size corresponding to those of the transparent board 21, and a shelter portion 231 is disposed at a side of the second board 23 and made of a cardboard or a sheet of paper, and the shelter portion 231 is disposed on a side of the second board 23 that is attached to the folding boards 212, such that the folding boards 212 are covered between the first board 22 and the second board 23. Further, the second board 23 is cut to have a foldable shelf 232, and the foldable shelf 232 comprises a longitudinal board 2321 and a transverse board 2322, both coupled to the second board 23, and the longitudinal board 2321 and the transverse board 2322 are intersected with each other. In other words, a portion of the longitudinal board 2321 is a portion of the transverse board 2322. Further, a writing area 233 is defined on the other side of the second board 24.

The content 24 is made of a cardboard cut into a flat plate structure, and the content 24 is inserted into the containing space 221, and a pattern area 241 is defined on a side of the content 24, and the pattern area 241 can be seen directly through the transparent board 21. It is noteworthy to point out that the content 24 is a paper decorative item such as a card and a photo or a magnetic decorative card or a small decorative item. In addition, the content 24 further has a bookmark 242, wherein the bookmark 242 is made of a non-toxic green plastic material such as PP, EVA or HDPE and attached onto the pattern area 241, or the bookmark 242 is made of a magnetic material and attached magnetically onto the pattern area 241 of the content 24, and the bookmark 242 can be used as a decoration attached onto a metal surface.

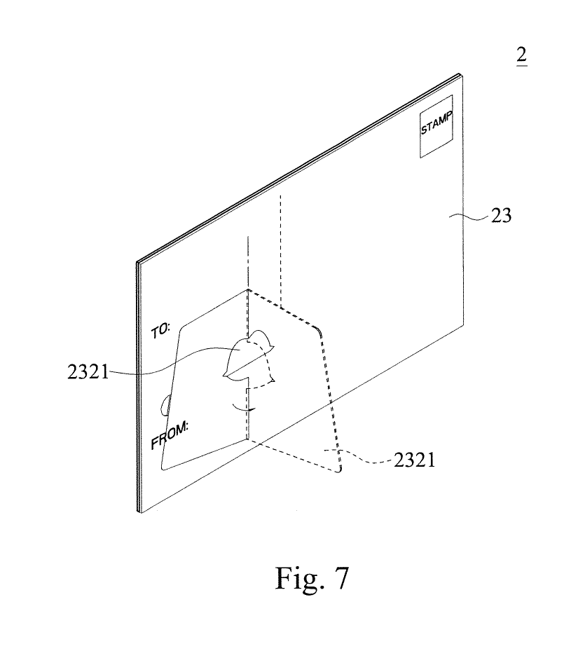

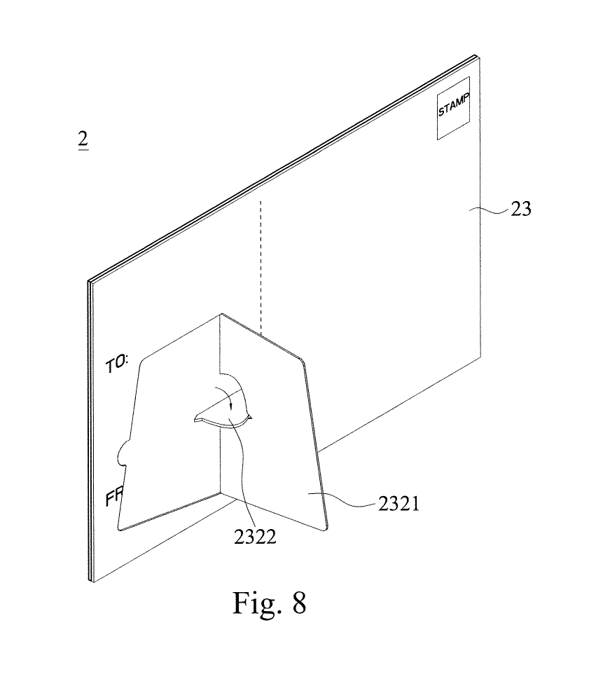

With reference to FIGS. 7 and 8 for schematic views of an operating procedure for an application as a photo frame in accordance with a preferred embodiment of the present invention, when the multifunctional postcard structure 2 of the invention is used, the longitudinal board 2321 is erected perpendicularly from the second board 23, and then the transverse board 2322 is erected perpendicularly from the second board 23, such that a portion of the transverse board 2322 and a portion of the longitudinal board 2321 are intersected and overlapped with each other, and the longitudinal board 2321 is used to erect the multifunctional postcard structure 2 from a plane perpendicularly, so as to use the postcard structure as a photo frame.

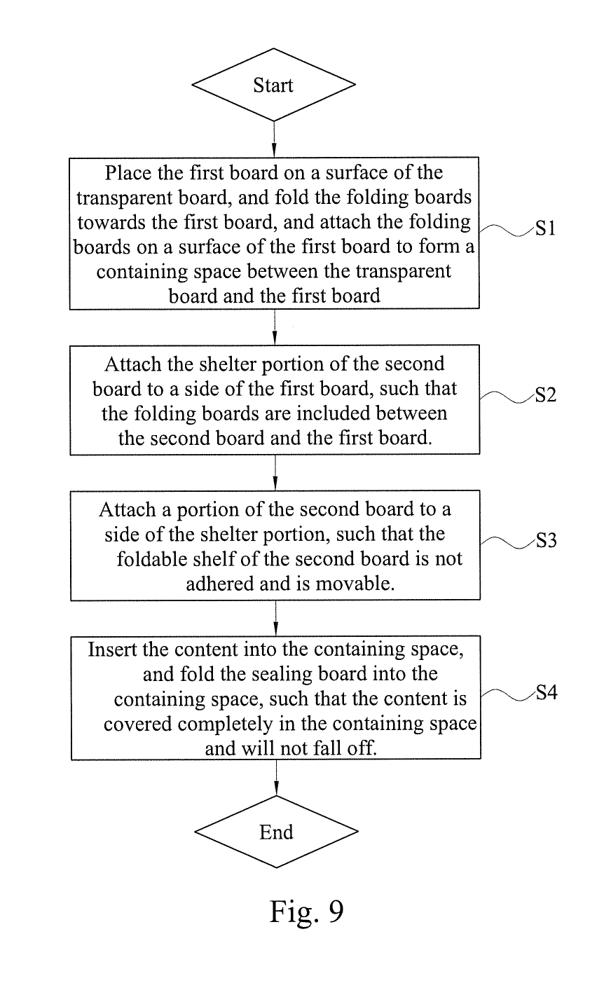

With reference to FIG. 9 for a manufacturing flow chart of a preferred embodiment of the present invention together with FIGS. 2 to 5, the manufacturing method of a multifunctional postcard structure 2 in accordance with the present invention comprises the following steps:

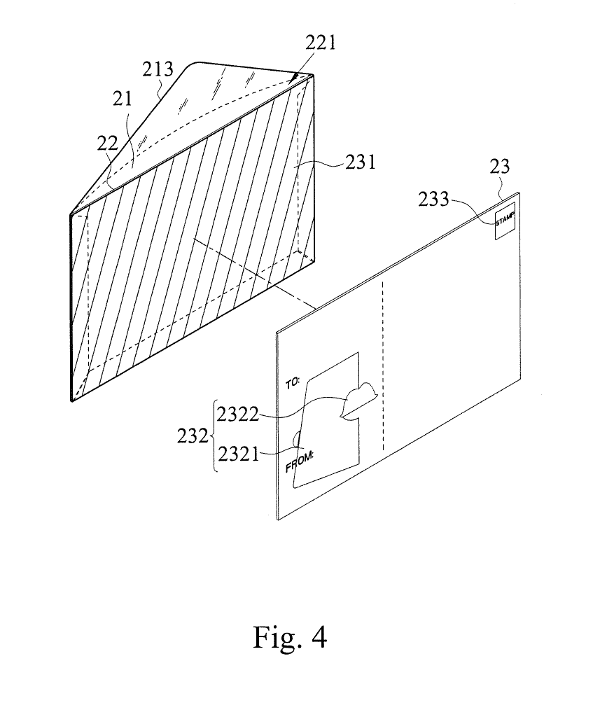

S1: Place the first board 22 on a surface of the transparent board 21, and fold the folding boards 212 towards the first board 22 and attach the folding boards 212 onto a surface of the first board 22 to form a containing space 221 between the transparent board 21 and the first board 22 (as shown in FIG. 4).

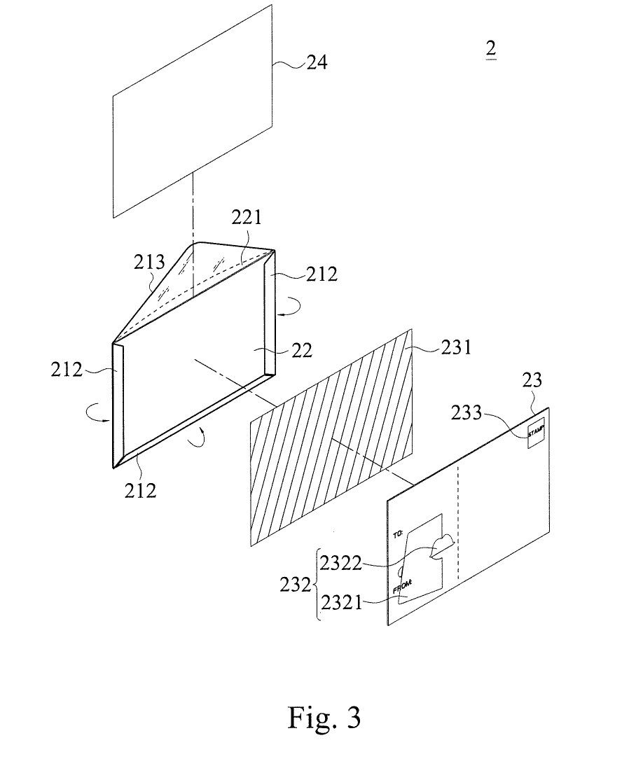

S2: Attach the shelter portion 231 of the second board 23 to a side of the first board 22, such that the folding boards 212 are included between the second board 23 and the first board 22 (as shown in FIG. 3).

S3: Attach a portion (particularly the periphery) of the second board 23 to a side of the shelter portion 231, such that the foldable shelf 232 of the second board 23 is not adhered and is movable (as shown in FIG. 4).

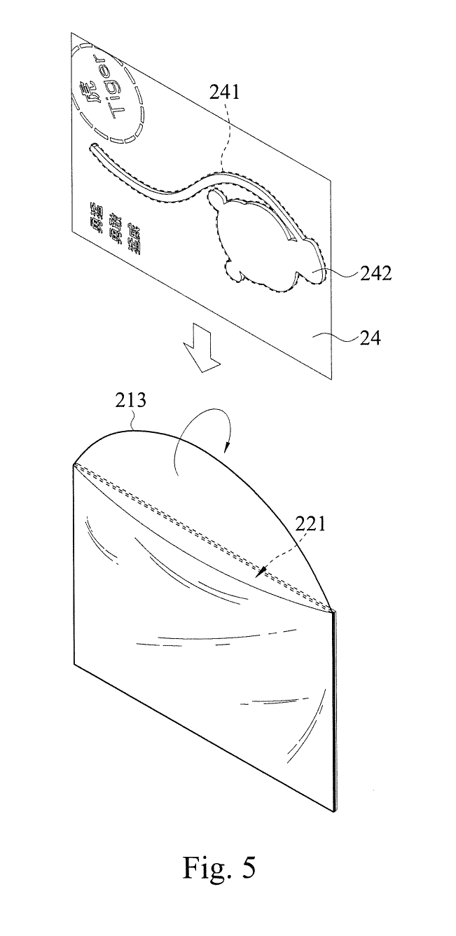

S4: Insert the content 24 into the containing space 221, and fold the sealing board 213 into the containing space 221, such that the content 24 is covered completely in the containing space and will not fall off (as shown in FIG. 5).

In summation, a containing space 221 is formed in the multifunctional postcard structure 2 for containing the content 24 such as a photo or a planar decorative item, storing the content 24 with several different patterns, providing a quick and convenient replacement to change the viewing effect, after the transparent board 21, the first board 22 and the second board 23 are attached with one another. Further, the design of the foldable shelf 232 of the second board 23 in accordance with the present invention allows the foldable shelf 232 to erect from a plane and to be used as a photo frame, so as to improve the practicability of the postcard structure. In addition, the content 24 of the present invention has a detachable bookmark 242, and viewers still can see the pattern area 241 after the bookmark 242 is detached, such that the decorative effect is still there, and the usage of the bookmark 242 is enhanced, so as to improve the practicability of the postcard structure.

While the invention has been described by means of specific embodiments, numerous modifications and variations could be made thereto by those skilled in the art without departing from the scope and spirit of the invention set forth in the claims.

What is claimed is:

1. A multifunctional postcard structure, comprising:
a transparent board, being a rectangular flat board structure with four edges, and having any three successive edges coupled to a folding board separately;
a first board, attached onto the same side of the folding boards, and a containing space being formed between the transparent board and the first board;
a second board, attached onto the other side of the folding boards, and the folding boards being covered between the first board and the second board; and
a content, placed in the containing space, and having a pattern area defined on a surface of the content and viewable through the transparent board directly.

2. The multifunctional postcard structure of claim 1, wherein the transparent board has a sealing board coupled to an edge without the folding board.

3. The multifunctional postcard structure of claim 2, wherein the sealing board is substantially in a triangular shape, and a corner of the sealing board not coupled to the transparent board is folded into the containing space.

4. The multifunctional postcard structure of claim 1, wherein the second board includes a writing area defined on a surface of the second board.

5. The multifunctional postcard structure of claim 1, wherein the second board further includes a foldable shelf.

6. The multifunctional postcard structure of claim 5, wherein the foldable shelf includes a longitudinal board and a transverse board, both coupled to the second board, and when the longitudinal board and the transverse board are perpendicular to the second board, the longitudinal board and the transverse board are intersected and overlapped with each other.

7. The multifunctional postcard structure of claim 6, wherein the second board further includes a shelter portion disposed on a surface where the second board and the folding boards are attached.

8. The multifunctional postcard structure of claim 1, wherein the content further includes a bookmark attached onto the pattern area.

9. The multifunctional postcard structure of claim 1, wherein the transparent board is made of a non-toxic green plastic material, and the first board, the second board and the content are made of a cardboard material.

10. A manufacturing method of the multifunctional postcard structure as described in claim 1, comprising the steps of:
setting the first board on a surface of the transparent board, folding the folding boards towards the first board, and attaching the folding boards onto a surface of the first board to form a containing space between the transparent board and the first board;
attaching the shelter portion of the second board onto a side of the first board, such that the folding boards are included between the second board and the first board;
attaching a portion of the second board to a side of the shelter portion, such that the foldable shelf of the second board is not adhered and is movable; and
inserting the content into the containing space, and folding the sealing board into the containing space, such that the content is covered in the containing space completely without falling out.
